(19) United States
(12) Patent Application Publication
(10) Pub. No.: US 2016/0063112 A1
(43) Pub. Date: Mar. 3, 2016

(54) SYSTEMS AND METHODS FOR ENABLING AN ELECTRONIC GRAPHICAL SEARCH SPACE OF A DATABASE

(71) Applicant: Swoop Search, LLC, Stillwater, MN (US)

(72) Inventors: Quinn Colton BOTTUM, Stillwater, MN (US); Michael Christopher BOTTUM, East Troy, WI (US); Rob JAUQUET, Madison, WI (US)

(73) Assignee: Swoop Search, LLC

(21) Appl. No.: 14/835,358

(22) Filed: Aug. 25, 2015

Related U.S. Application Data
(60) Provisional application No. 62/041,763, filed on Aug. 26, 2014.

(51) Int. Cl. G06F 17/30

(52) U.S. Cl. CPC G06F 17/30864; G06F 17/30663

(57) ABSTRACT

Systems and methods are disclosed for enabling Internet users to interact with a graphical search interface. One method includes receiving an analytic to be queried; generating an analytic parameter, based on the received analytic; receiving a search parameter; generating a multi-dimensional search space, based on the generated analytic parameter and the received search parameter, wherein the multi-dimensional search space has a perimeter defined by the generated analytic parameter and the received search parameter; transmitting a graphical interface projecting the multi-dimensional search space, along with one or more user elements by which the user may adjust a weighting of one or more of the generated analytic parameter and the received search parameter by interacting with the one or more user elements; and transmitting a plurality of search results automatically updated in real time based on the user-adjusted weighting of the generated analytic parameter and the received search parameter.

### CROSS REFERENCE TO RELATED APPLICATIONS

This application claims the benefit of priority from U.S. Provisional Application No. 62/041,763, filed Aug. 26, 2014, which is herein incorporated by reference in its entirety.

### TECHNICAL FIELD

The present disclosure is directed toward providing an intuitive means of representing and manipulating the weightings of search parameters employed by database search algorithms. In particular, the present disclosure relates to an intuitive system to create, control, and interact with statistical analytics through a graphical search user interface.

### BACKGROUND

One of the great identities of the 21st century is that of connection of people, businesses, and things to a network. Each connection to a network creates data. Connections between networks create additional data, and the behaviors of humans interacting with the created data serves to create additional data. The end result is a vast, ever growing, and ever changing store of vital information to be leveraged and acted upon. Data is the natural resource of the 21st century.

While the world has built up this massive store of data, questions of how best to use it have also surfaced at an ever-increasing rate. The data that the world has and continues to accumulate is a rich store of human, machine, and world behavior. Contained within this store are factual accounts of how businesses operate, machines function, diseases progress, medications work, terrorists plan, and markets move, among endless others. However, also contained within the data are false promises of correlation rather than causation, signals of mistaken intent, and, just as important, the falsity of the size of the data. Compounding the issue is the fact that data is constantly changing. What was a factual account contained within the data can become a false correlation in rapid fashion, as can the reverse transformation. While the worldwide store of data is massive, its mass itself is one of its most significant issues impacting use of the data. This issue can be broken into three separate parts.

The worldwide data created must be stored if one intends to use it. As a technological people, there have many forms of storage, all with differing use cases that drive the application of the respective storage strategies. Does one store the data in a file system, a disk, in memory, in the cloud, or potentially in paper form? The previously stated storage options are only a small subset of a much larger option set any particular actor can choose from. This diversity of storage strategies causes a fragmentation of how the worldwide data is housed. Even within a single business, multiple storage strategies may be undertaken so as to best optimize the business's storage of its multi-faceted data. Optimization is the practical solution to multi-faceted data; however, it causes the platform for which data is access to become multi-faceted and without standardization.

The worldwide data store is also inherently diverse in its structure. As data is the digital and machine footprint of human life, it seems appropriate that data must be diverse in structure, as human life and the behavior it encompasses is diverse in nature. An airplane flying across a country produces signal data that is not congruent to a Facebook user's comment to a friend about a broadcast television segment he just watched. Technology has solved this problem by designing and implementing a vast selection of data models, structures, and databases to organize and provide understandable access to the data. Out of desire to optimize for use cases associated with data, as a technological people, de-standardized is how data is stored and approached.

While the paragraphs above discussed the pragmatic storage and structure heterogeneity de-standardizing the worldwide store of data, the third problem associated with the size of the data is an age-old maxim of, quantity vs. quality. As discussed above, the size of the data has created a de-standardized platform to access and store data. However, compounding the issue is simply how much data there is. How does an actor know whether or not he is looking at the correct subset of data to solve a problem? How does an actor know that the most important problem contained within a data store is the one he discovered and is working on? How does an actor know whether two seemingly disparate patterns within the data are not actually connected and create a much more significant pattern when approached in concert? These are problems that the size of the worldwide data creates, and they are important because contained within this data is the vitality of the natural resource that is data; insight.

The experts in the field have termed the above stated state of data as “big data.” To solve the de-standardization and size of data problems associated with “big data” the technological people have created business intelligence, analytics, predictive analytics, machine learning platforms, and many other different types of technologies to elicit insight from the flood of information and miss-information. Each of these categories of solutions to data problems offers benefits at their particular use case goals. However, many of these solutions force the users of the technology to operate and interact with data in pre-determined and inflexible manners. This creates the following problems for users charged with understanding the data.

Users have to use current reporting-centric technologies to do their analysis, which means they have to determine a hypothesis, and then hard set it to the data they want to evaluate. This gives a single viewpoint into the data, introducing the risk that they are missing actionable insights contained within the data, as well as the risk they are being misled by the wrong reporting metrics that they were forced to introduce.

The tools to do reporting, which are geared toward specified data structures, introduce the time-constraining need for traditional business users to learn multiple different systems and tools to do their analysis.

The previously described issues and problems corresponding to the nature of big data demand solutions that place a priority on finding new ways to leverage human intuition and thought to work in tandem with systems related to analysis of the worldwide data to elicit insight retrieval.

### SUMMARY

According to certain embodiments of the present disclosure, a computer-implemented method is provided for enabling Internet users to interact with a graphical search interface. One method including receiving, from a user over an electronic network, an analytic to be queried; generating, by a processor, an analytic parameter, based on the received analytic; receiving, from the user over the electronic network, a search parameter; generating, by the processor, a multi-dimensional search space, based on the generated analytic parameter and the received search parameter, wherein the multi-dimensional search space has a perimeter defined by the generated analytic parameter and the received search parameter; transmitting, for display to the user over the network, a graphical interface projecting the multi-dimensional search space, along with one or more user elements by which the user may adjust a weighting of one or more of the generated analytic parameter and the received search parameter by interacting with the one or more user elements; and transmitting, for display to the user over the network, a plurality of search results automatically updated in real time based on the user-adjusted weighting of the generated analytic parameter and the received search parameter.

According to additional embodiments of the present disclosure, a system is provided for enabling Internet users to interact with a graphical search interface. One system includes: a data storage device that stores instructions for enabling Internet users to interact with a graphical search interface; and a processor configured to execute the instructions to perform a method including: receiving, from a user over an electronic network, an analytic to be queried; generating, by a processor, an analytic parameter, based on the received analytic; receiving, from the user over the electronic network, a search parameter; generating, by the processor, a multi-dimensional search space, based on the generated analytic parameter and the received search parameter, wherein the multi-dimensional search space has a perimeter defined by the generated analytic parameter and the received search parameter; transmitting, for display to the user over the network, a graphical interface projecting the multi-dimensional search space, along with one or more user elements by which the user may adjust a weighting of one or more of the generated analytic parameter and the received search parameter by interacting with the one or more user elements; and transmitting, for display to the user over the network, a plurality of search results automatically updated in real time based on the user-adjusted weighting of the generated analytic parameter and the received search parameter.

According to additional embodiments of the present disclosure, a non-transitory computer-readable medium is provided for storing instructions that, when executed by a computer, cause the computer to perform a method for enabling Internet users to interact with a graphical search interface. One computer-readable medium includes instructions that, when executed by a computer, cause the computer to perform a method for enabling Internet users to interact with a graphical search interface, the method including: receiving, from a user over an electronic network, an analytic to be queried; generating, by a processor, an analytic parameter, based on the received analytic; receiving, from the user over the electronic network, a search parameter; generating, by the processor, a multi-dimensional search space, based on the generated analytic parameter and the received search parameter, wherein the multi-dimensional search space has a perimeter defined by the generated analytic parameter and the received search parameter; transmitting, for display to the user over the network, a graphical interface projecting the multi-dimensional search space, along with one or more user elements by which the user may adjust a weighting of one or more of the generated analytic parameter and the received search parameter by interacting with the one or more user elements; and transmitting, for display to the user over the network, a plurality of search results automatically updated in real time based on the user-adjusted weighting of the generated analytic parameter and the received search parameter.

Additional embodiments and advantages will be set forth in part in the description which follows, and in part will be obvious from the description, or may be learned by practice of the disclosure. The embodiments and advantages will be realized and attained by means of the elements and combinations particularly pointed out below.

### BRIEF DESCRIPTION OF THE DRAWINGS

The accompanying drawings, which are incorporated in and constitute a part of this specification, illustrate several embodiments and together with the description, serve to explain the principles of the disclosure.

FIG. 1 depicts one example of a typical search engine output.

FIG. 2 depicts one example of a typical search engine related search suggestions output.

FIG. 3 depicts an exemplary “search space” two-dimensional projection with vertices populated with search suggestion output, consistent with the presently disclosed graphical search interface.

FIG. 4 depicts an exemplary reconfigured graphical “search space” projection, consistent with the presently disclosed graphical search interface.

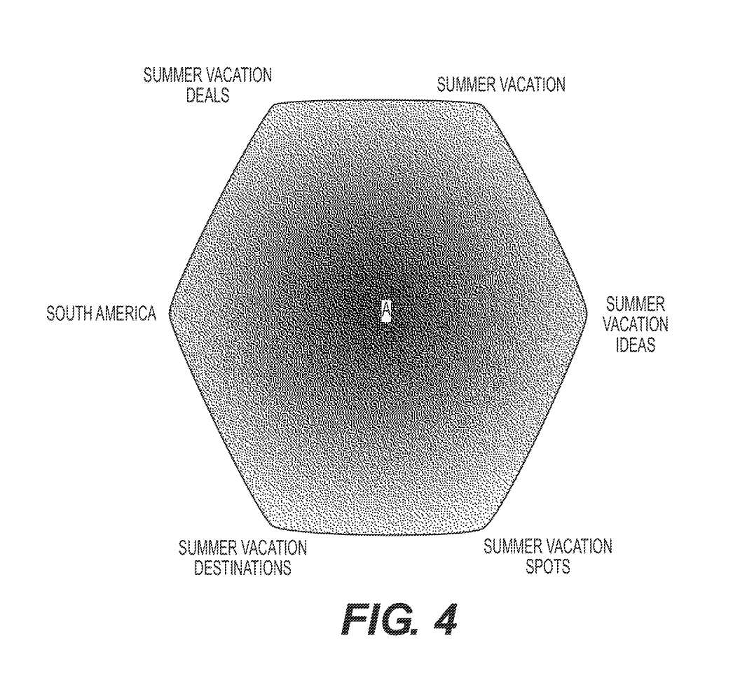

FIG. 5 depicts an exemplary “search space” projection weighting, e.g., vacation deals in South America, consistent with the presently disclosed graphical search interface.

FIG. 6 depicts an exemplary “search space” projection for, e.g., summer vacation with social network profile applied in ‘search within’ mode, consistent with the presently disclosed graphical search interface.

FIG. 7 depicts an exemplary “search space” projection for, e.g., summer vacation with social network profile applied in ‘search beyond’ mode, consistent with the presently disclosed graphical search interface.

FIG. 8 depicts a block diagram of an exemplary method for enabling and using the presently disclosed graphical search interfaces.

FIG. 9 depicts an SDA framework that enables a method to perform comparative analytics, according to embodiments of the disclosure.

FIG. 10 depicts an SDA framework that enables another method to perform comparative analytics, according to embodiments of the disclosure.

FIG. 11 depicts an exemplary environment and systems for enabling and using the presently disclosed graphical search interfaces.

### DETAILED DESCRIPTION

This disclosure relates to systems and methods that prioritize translating human intuition and thought so that it can be an augmenting agent unified with the hyper efficient and computationally powerful machine logic, can reap significant benefits in a quest to more accurately and effectively navigate and elicit insight out of big data. The human intuition and thought serve as the navigating power that drives the machine logic's performance. This disclosure relates to a graphical user interface that gives users a means of representing and manipulating the weightings of search parameters employed by database search algorithms. Within this framework of graphically weighted search, the systems and methods create a methodology for translating the explorative nature contained within human intuition and thought into machine logic to achieve enhanced search through data.

The natural next step to creating a human-centric system to elicit insight from big data with search is to provide the capability for assessment and analysis to be performed within the same framework. Search retrieves information upon which an individual has to make an assessment upon the quality of the returned dataset. The platform relates to prioritizing the translation of human intuition and thought into machine logic for search. A second part of the framework is application of relevant processes of analysis to be defined and applied to the information returned by the user focused query. Within this dual function framework, the user is able to in parallel achieve translation of human intuition and thought into machine logic to direct the computer algorithms to perform discovery (search) and analysis (statistical analytics). This creates a more directed, efficient, iterative, and effective means to elicit information from the worldwide data store.

Specifically, this disclosure relates to search driven analytics (“SDA”). Central to SDA is the ability to specify a statistical analytic of interest to the user and then execute the analytic as the user searches through data. Within this framework, each time a user performs a search or weights (or re-weights) a search parameter within the query, the system returns a record set of data that is immediately in real time used to perform the statistical analytic specified by the user. In this system, the search and analytics capabilities are delivered to a user in parallel, with information retrieval and information analysis both performed for every query generated by the user. Additionally, the presentation of search results and statistical analytic results are both visualized to the user on the same screen. The statistical analytics can be thought of as a user controlled and implemented assessment of whether the returned dataset from the search elicits insight from big data.

For a system that relies upon human intuition and thought to perform statistical analytics to function appropriately, it is important to allow for configurability and iteration to be performed dynamically, in real time, and with minimal restrictions upon user expression of human intuition and thought for translation. SDA accomplishes this by allowing two functions to be performed. First, it allows the user to choose from a library of analytics to be applied to a search query's returned dataset. The selected analytics are quickly joined with the search algorithm and weighting algorithm to execute together. Once the weighting algorithm has retrieved results, those results are immediately run through the selected analytics. The query results—record set—and analytics results—processed insights—are returned to the user in parallel, allowing for more comprehensive assessment.

Second, the user is able to develop an analytic directly in the analytics dashboard, custom tailored to some intuition triggered through a previous search result or statistical analytic result. The SDA thereby acts as an analytic filter, segmenting returned data (records) into unique sets defined by analytic algorithms and models. Both options allow for the user to more effectively and quickly iterate and re-configure statistical analytic deployment upon returned datasets.

While this disclosure has discussed search and statistical analytics as parallel yet disparate functions, an SDA platform also allows the joining of the capabilities into one experience. The user is able to use analytics as an actual search query parameter by intuitively dragging the analytic (bar from a bar graph, line segment from a line graph, wedge from a pie chart, among others) into the graphical search user interface (“Search Space”). The SDA platform identifies commonalities of records within the unique sets, creating a set vector whose magnitude is the degree of commonality, and direction, the commonalities themselves. As an example, but not limited to this example, the number of times most common strings appear in text fields could be used as an analytic. It should be noted that if the analytic model is set to filter out matches to original search parameters, truly novel information will be revealed. The SDA platform then allows the set vector itself to be used as a search parameter. Furthermore, this allows segments of the key-value array to be weighted congruently with how the user is defining importance within the statistical analytic itself.

Lastly, the SDA framework allows for analytics derived and developed in one experience to be performed upon alternative datasets, or used as an alert system for when the insight discovered within the statistical analytic repeat itself or a specified deviation of itself. This functionality allows for bases of knowledge and understanding to be built and then leveraged into more quickly applied statistical assessments of differing datasets.

Reference will now be made in detail to exemplary embodiments, examples of which are illustrated in the accompanying drawings. Wherever possible, the same reference numbers will be used throughout the drawings to refer to the same or like parts.

It should be noted from the outset that the graphical user interface consistent with the present disclosure, and as explained in this description, may be employed with an SDA framework, a database search algorithm, and a search engine capable of examining multiple search parameters in determining optimal match output.

The capability of the presently disclosed graphical search interface of visualizing and reorienting search engine output as specified by the user's goals, preferences, and needs can be illustrated through using a search for ‘summer vacations’ as an example.

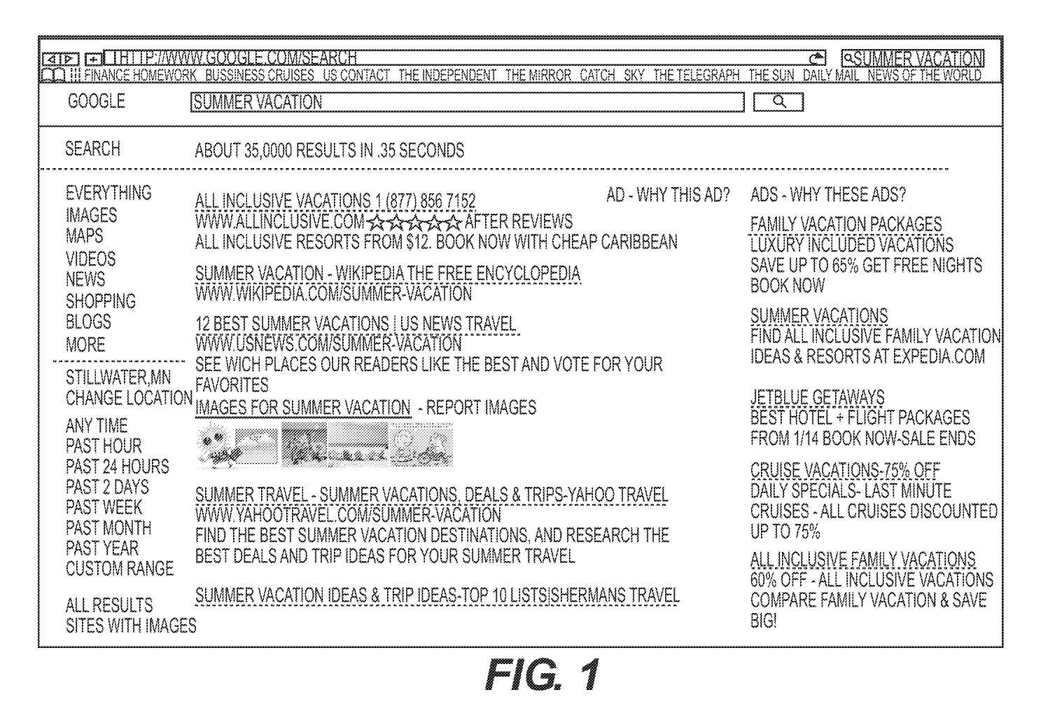

If the user was to enter the search parameter ‘summer vacation’ into Google's search engine, the output would be similar to the screen shot displayed in FIG. 1.

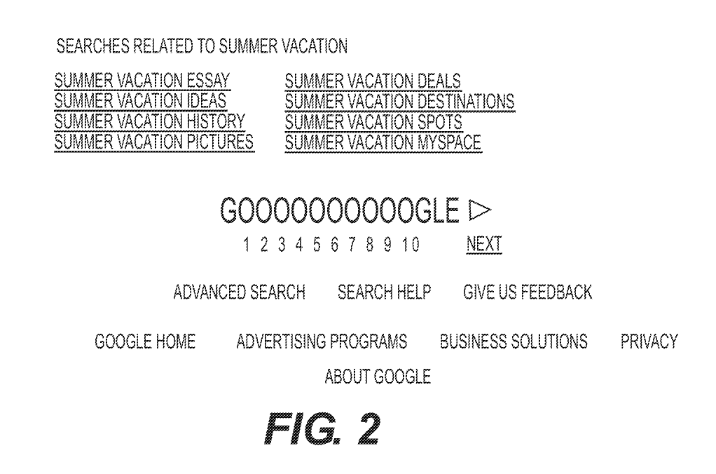

As shown in FIG. 1, the output is impersonal in the sense that it is a generic output that does not adequately address the users goals, preferences, or needs; and two, it displays the output in a list of hyperlinks potentially requiring the user to scan pages of information. In addition to these problems, the related searches that existing search engines produce at the bottom of the initial search output page are numerous and call for extensive cross referencing of search outputs in order to determine optimal results (FIG. 2).

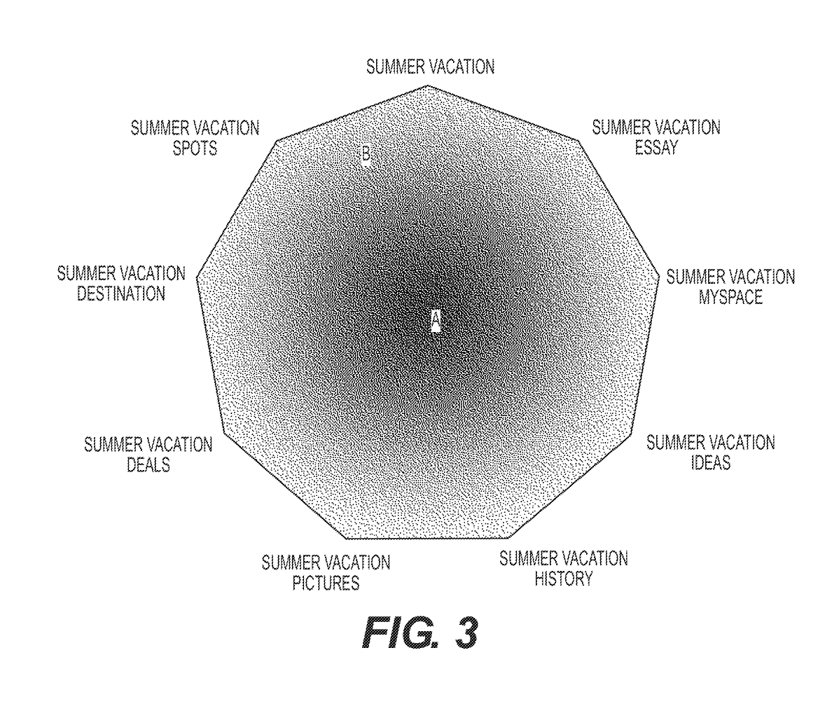

The presently disclosed graphical search interface would provide the following graphical output immediately after the initial search parameter was entered as represented in FIG. 3. The initial search parameter may include a predetermined weight, and the initial graphical output may project a radial search space shape whose vertices are populated with the initial search parameter, along with related searches that may be generated (FIG. 3). In one embodiment, the initial search parameters may be obtained in the input box where the user initially interfaces with the search technology. In one embodiment, parser modules may then use regexes to then define the search terms to understand the user search parameters. Once the computer processing device understands the search parameters, the search parameters may be extracted, and represented in the graphical search space. In one embodiment, this may be performed using a draw function in JavaScript that scales with the amount of words extracted by the parser modules. The draw function may create a geometric shape with the vertices comprising the extracted user search terms.

Each vertex, then represents a search parameter. The maximum and minimum number of search parameters may be default or user defined. Contained within the search space shape may be a matrix of hyperlinks related to all parameters. A given hyperlink's coordinates inside the search space may be determined by its relevance to the search parameters. Nearer proximity represents higher relevance between a hyperlink and a search parameter. The middle region of the search space represents search output generated by equally weighting all search space parameters. Thus the center of the search space may represent an optimal hit subset, most equally relevant to all search parameters—labeled ‘A’ in FIG. 3. However, as described above, the search parameters may not be equally weighted. For instance, in certain embodiments, search parameters and the resulting search space may reflect a higher order relative weighting for two or more neighboring search parameters.

As described above, the graphical search space may be a Euclidean space that takes the spatial representation of the user's search parameters and derives from it coordinate points for each parameter. The coordinate point for each term may be determined using Euclidean geometry, assessing the point from two analytical frameworks: (1) how far is the point from the radial center of the graphical search space; and (2) how far away from the other search parameters is the point? The answer to the second analytical framework may create a relative association between the parameter in question, and the surrounding parameters. The relative association weighting may exist to describe the associative hierarchy existing amongst the user's search parameters in the graphical search space. Both the direct coordinate and the relative distances may be used to create a final parameter weighting that is assigned to the search parameter. Because these distances may be derived from a pair of Euclidean coordinate points from the underlying Euclidean geometry framework of the graphical search space, each of the distances may be translated into a decimal point weighting on a scale of 0 to 1.

In one embodiment, any movement of search parameters within the graphical search space may be captured within the spatial coordinate system and used to create the weight of the search parameters within the graphical search space. This may be a binary construct in that the weighting may be done in two parts, first, spatial distance between parameter and the radial center of the graphical search space, and second, the spatial distances and angles between parameters in the graphical search space. Within the first weighting construct, the closer the spatial distance between the parameter and the radial center, the greater the weighting applied to the search parameter. Within the second weighting construct, the spatial representation between the search parameters in the graphical search space may be captured using the distances and angles between parameters, applied within a Euclidean geometry framework. Thus, the relative weightings of parameters may be derived as described above, which is useful to the construction of the weighting of search parameters. As an alternative embodiment, if the radial center were moved, the construction of the above discussed binary system would occur again, updating the previously derived weightings of the search parameters. The use of a spatial Euclidean geometric coordinate system may allow scalability and heightened configurability options, and may break user interaction within the graphical search space down into quantified numeric interactions within a pre-defined mathematical framework that allows for scale invariant use.

In one embodiment, a hyperlink within the database may be defined by its parameters of interest. These parameters of interest may then be used to create the framework for assigning the graphical interface weights to the hyperlinks. The parameters of interest defining the hyperlinks—or result options—within the database may correspond to the parsing modules that are used to extract user search parameters from the input box. Therefore, when a weight is derived from the graphical search space, it may be used to create a query call to the database. This query call may place the respective weights into the correct framework designations for the corresponding parameters of interest within the database. Once the weights are assigned into the database, an additional call may be performed to score each hyperlink on two criteria. First, does the hyperlink have the parsed parameters of interest? If yes—for each parameter, the value may be assigned a 1. If no, it may be assigned a 0. Next, the weights may be scored for each hyperlink. If the hyperlink scored a 1 for a parameter of interests in the first stage, the corresponding weight may then be multiplied against the 1. In one embodiment, if hyperlink is true (1) for a parameter, then the parameter weight may be multiplied against the parameter's term frequency—inverse document frequency (“TFIDF”) value (or some other metric) for that hyperlink. Then, a summing the product to a running total weight or score for that hyperlink may be performed. Once all scoring has been completed, the mathematical scores for all parameters of interests corresponding to the user's search and the hyperlink may be totaled, and the dataset may be sorted given the numerical scores for each hyperlink.

In one embodiment, a second weighting algorithm based on key-value arrays may be used. For example, a user search parameter, extracted, and placed into the graphical search space in the same manner described above, may be representative of its key-value array in this algorithm. In other words, the parameter may be representative of all of its underlying characteristics and parameters of interest. Each characteristic or parameter of interest may be represented as a key-value pair. These key-value pairs may create an array that is connected to the user generated search parameter. When the user weights the individual search parameter, that weight may be cascaded across the underlying key-value array. When the key-value array is used to call the database for hyperlinks, the entirety of the key-value array may be used as the algorithm, and the weightings may all be sent as well. This weighting algorithm may allow for multi-dimensional weighting, and may be more efficient than assessing each parameter on a singular and isolated basis. Additionally, when more than one key-value array is populated in the graphical search space, the key value arrays may be matched and searched against one another, with the weightings generated by the user used as the mathematical system to assigning association and priority to the matching of key-value pairs amongst search parameters. This may allow for a much-improved weighting algorithm because it uses disparate data elements that may not have been initially associated to create enhanced clusters of associations with heightened signal. When the algorithm is sent into the database, it is a much more holistic method to extract relevant hyperlinks.

The following is a detailed description of an SDA framework that allows for human intuition and thought translation into machine logic for statistical analysis of returned search result datasets. The central function of the SDA framework is to allow the user to specify statistical analytics that he/she would like executed upon the returned dataset from a search query. Furthermore, if the user weights or re-weights a parameter from the given search query, the statistical analysis may be re-run to describe the effect the weight had on the returned dataset. The SDA platform allows for information retrieval and discovery to be performed in tandem to a system that assesses the quality of the retrieved information through the context of the user-defined statistical analytic(s). The result of this system is a presentation of both the results from the search as well as the visualized statistical analytics, whether that is in bar, line, pie, or histogram form, among many others.

The SDA framework gives a user statistical frameworks to formulate analytics to be applied within the SDA framework. It should be disclosed that the following examples serve as further explanation and description, and that the functionality of the SDA framework should not be limited to said frameworks. A user may group the returned dataset into bins representing terms in a static list. The user may also specify a dictionary of terms that they find important and would like exposed statistically from the returned dataset of a search query. When applied, the returned dataset may be run through this statistical analytic, and the different user-defined library of terms may be individually parsed out of the dataset, counted, ordered, and then represented within a graphical representation of the results. Additionally, the SDA framework may give users a statistical framework to partition returned datasets into bins representing keys of a static dictionary of terms where the key is the representative term, and a value list represents the terms to match. For example, if the dataset is medical based, a user might specify for the key cardiovascular disorder (key) he wanted ventricular tachycardia (value) parsed and counted into the corresponding bin.

The SDA platform allows for a user to react to a search result by specifying a dictionary of terms or key-value pairs to be parsed, counted, and communicated to the user via graphical representation upon every search query performed through the search space. This capability allows for real-time, human-driven assessment of the quality, as well as relevance, of the search results at a comprehensive level. While the SDA framework is beneficial for eliciting singular records from a returned record set that prove insightful and actionable to a user, the SDA framework may also be viewed as a means to assess the entire returned dataset as a whole through the context of how the user is defining value and importance at that point in time. The SDA framework provides users with the functionality to access, from the analytics dashboard on the search results screen, a library of statistical analytics as well as analytic construction engine to react iteratively off the insights elicited from the returned dataset. This system of query, analyze, react not only allows for more iterative discovery within big data, but it also allows for re-configurable analytics dashboards to be generated by non-technical users of data for more effective elicitation of insights from big data.

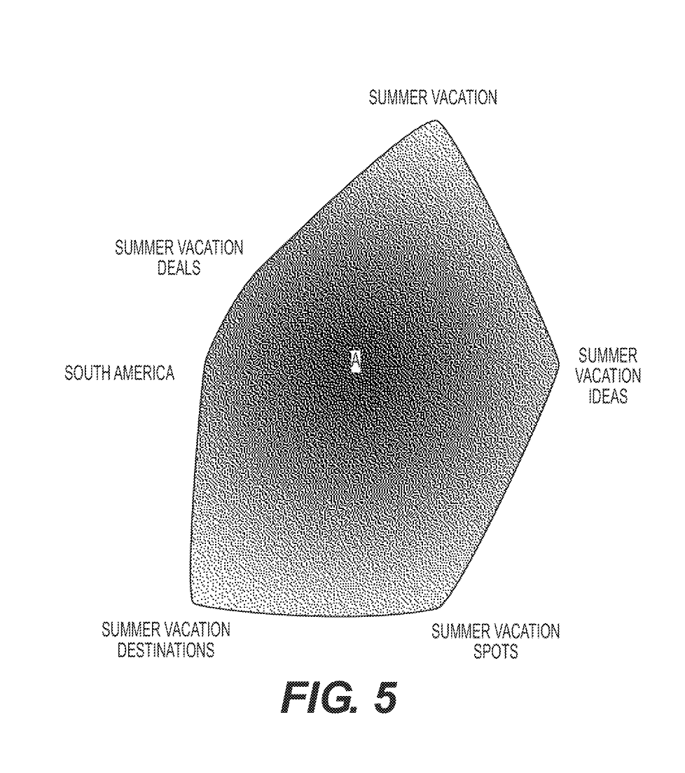

In order to view a result contained within the graphic, the user may highlight the point on the graphic that is in tune with his/her goals, preferences, and needs, and the interface will display a list of results common to that search region. If the initial search space output does match the user's intentions, the interface presents the user the capability of reconfiguring the search by dragging individual parameters toward (increasing weight), away from (decreasing weight), or completely away from (eliminating parameter) the shape center (FIG. 5). As the search space dimensions are reconfigured, its coordinate system is continually repopulated with the updated results, such as a hyperlink matrix. In this way, the presently disclosed graphical search interface allows for users to intuitively perform a search in unison with their mental criteria for what a successful search will generate. In one embodiment, the search parameter point within the graphical search space may be scaled in size proportionate to weighting that is being derived from the spatial distance between the search parameter and the radial center of the graphical search space. The size of the search parameter point may be increased on a linearly proportionate scale relative to the weighting. This increased size may describe intuitively to the user the increased significance he or she is expressing to the search engine. In another embodiment, the relative weighting of two parameters may be visually described by increasing the thickness of the line drawn to connect the two search parameters within the graphical search space. It is worth noting that no matter how many parameters entered into the graphical search space, the graphical search engine may construct a geometric shape within the graphical search space, with the respective search parameters represented by points, and the points connected to create a geometric shape. The increased thickness between two points may be linearly proportionate to the derived relative weighing that the user expresses to the search engine.

It should be noted at this point that two parameter cross-referencing search modes exist within the presently disclosed graphical search interface: quick search and web search. In the quick search mode, a parameter's relative radial distance to the center of the search space may be compared to the radial distance of other parameters. This mode enables quicker searching since the absolute order of parameters about the search space perimeter does not factor into the overall search. In web search mode, the search weight of a parameter is determined by its radial distance to the search space center, as well as distances to all other search parameters. This mode may involve reordering of parameter order, requiring additional interface time, though producing more parameter detailed output.

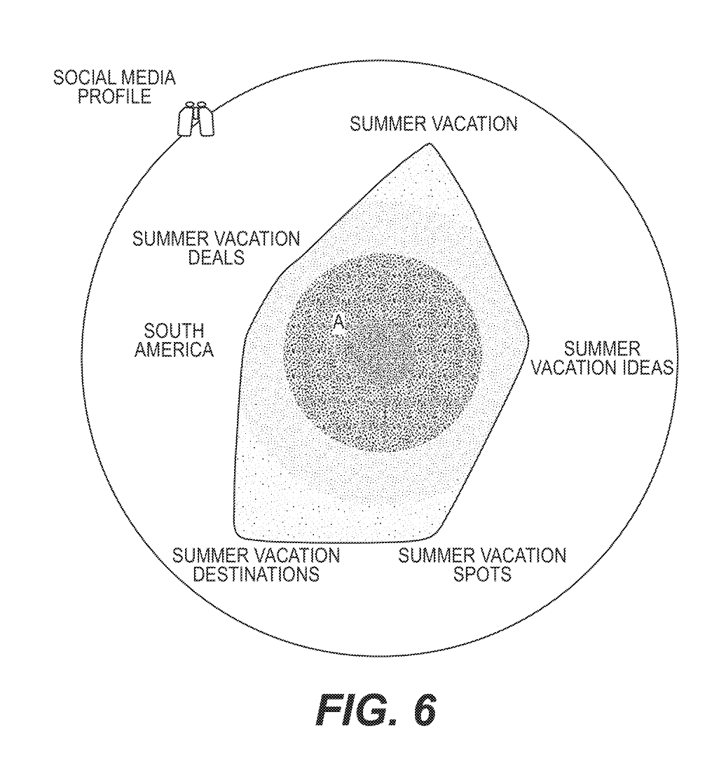

Additionally, the presently disclosed graphical search interface provides a means for the user to intuitively perform searches across seeming non-compatible data bases. Comparing value preferences of a user's social network database, loosely considered intrinsic data, with extrinsic data sets, such as lists of films offered through a video streaming website may be performed with the presently disclosed graphical search interface, as follows. Suppose the user wishes to conduct a search looking for a film based on how his social network preferences would value each of the search space initial search parameters; say, thriller films, foreign films, and films produced before the year 2000. To engage this ‘search within’ protocol, the user would simply encircle the graphical search space with the user's social network icon to search for hits within the network preferences (FIG. 6), such as within social network databases such as Facebook and Google+.

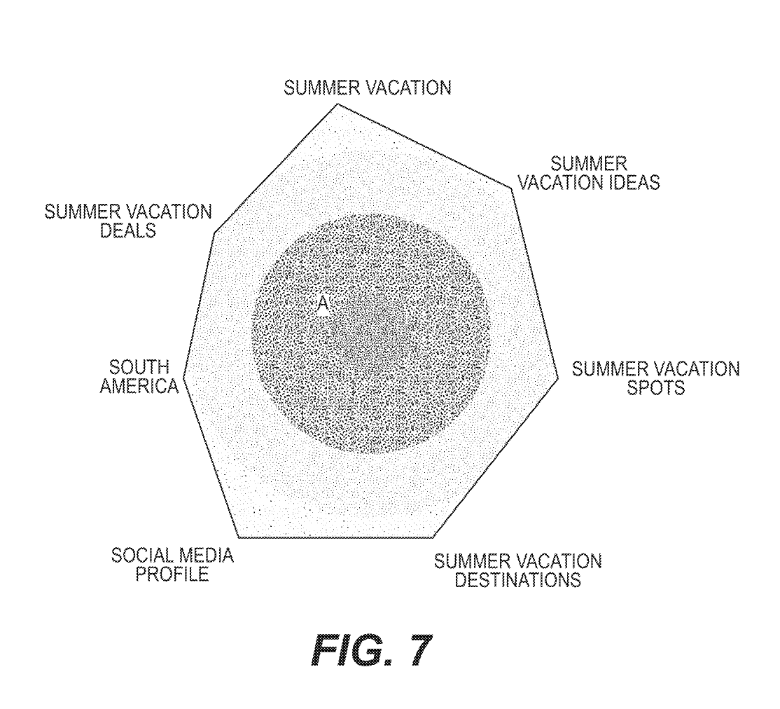

If, on the other hand, the user wishes to include his/her social network preferences as an additional parameter to the search space, and ‘search beyond’ profile preferences, he/she would simply drag the social network icon inside of the search space, allowing it to populate along the search space perimeter—currently possible only through performing multiple searches and extensive cross referencing (FIG. 7). In either search, the user's final choice would update his/her value preferences of their network profile. The intricacies of these two search strategies create significant effects on a user's social network profile and, potentially, social behavior. Choices made through the ‘search within’ protocol, although comfortable to the user, and predictable to the marketer, provide no new social fodder, nothing new is added to the behavioral ‘gene pool’ of the user. Networks of this type become quickly saturated and stale of market potential. The ‘search beyond’ strategy provides the appeal of including personal preferences, while potentially introducing new information and diversifying social networks. Diverse social networks are more robust, adaptable to change, and provide a greater range of investment opportunities.

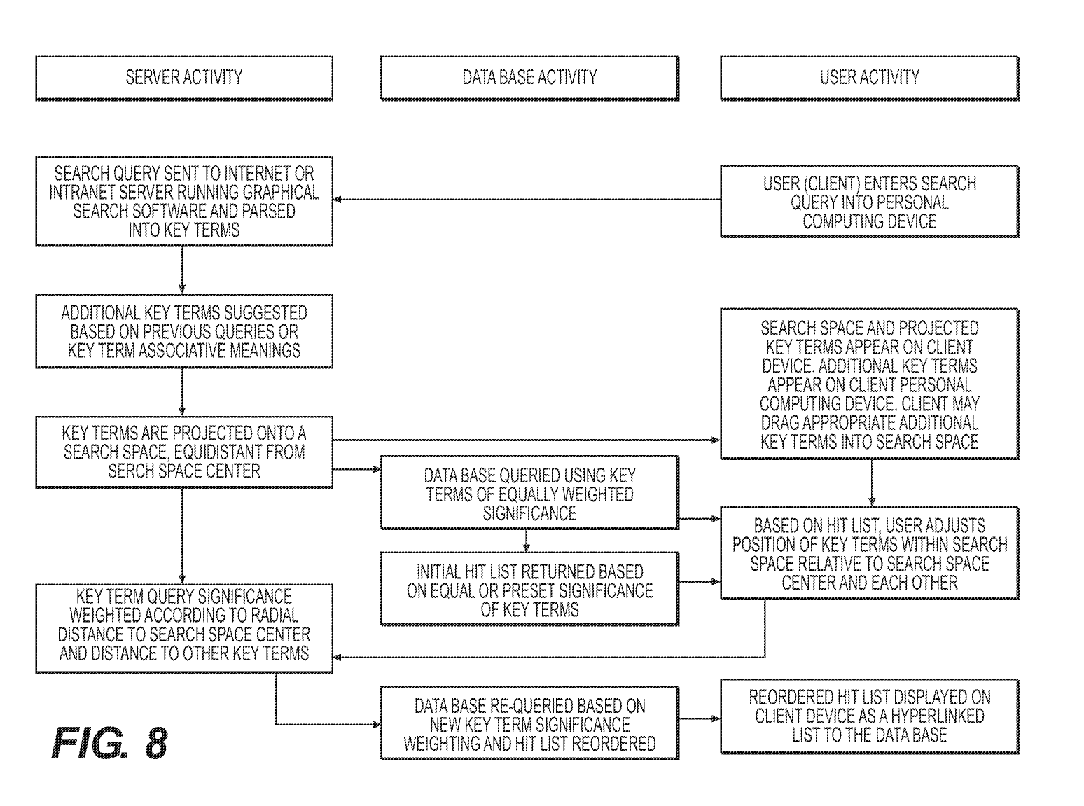

FIG. 8 depicts a block diagram of an exemplary method for enabling and using the presently disclosed graphical search interfaces. Specifically, FIG. 8 depicts an exemplary method including user, database, and server activity. However, it should be appreciated that any of the depicted steps may be performed by any other of the user, database, and server, and that the depicted steps may be performed in any order. Moreover, the exemplary method may include additional steps not depicted, or may omit any of the depicted steps.

In one embodiment, the method of FIG. 8 may include the user, entering a search query into a personal computing device. The search query may be sent to the Internet or intranet server running graphical search software, and parsed into key terms. In one embodiment, the graphical search server may suggest additional key terms based on previous queries and/or key term associative meanings, and then project key terms onto a search space, equidistant from a search space center. Since the search space and projected key terms (and optionally additional key terms) may appear on the client device, the client may drag appropriate additional key terms into the search space.

In addition, the method of FIG. 8 may include querying the database using key terms of equally weighted significance. The database and/or search server may return an initial hit list based on equal or preset significance of key terms. In certain embodiments, neighboring vertices of two or more parameters may be assigned a higher order relative weighting if they are determined or designated by a user to be more related than other parameters. Based on the hit list, the user may adjust a position of key terms within the search space relative to the search space center and/or each other. Meanwhile, the graphical search server may weight key term query significance according to radial distance to search space center and distance to other key terms.

As the user adjusts the relative position of key terms within the search space, and the server updates weights of key terms according to their distances, the database may be re-queried based on the updated key term significance weightings and the hit list may be re-ordered. The re-ordered hit list may then be displayed on the client device as a results list to the database.

Every time a user creates a statistical analytic or applies a statistical analytic from the SDA framework, the system may record the event, and populate it into a statistical analytic network. Each statistical analytic in this network may be given a profile page. Contained within the profile page is the statistical framework that the statistical analytic leverages for its data assessment, the optimal data structure and type to apply the statistical analytic to, the log of past uses of the analytic, a log of past users of the statistical analytic, and a list of possible visualization techniques for the statistical analytic. This network of profiles can be exposed to a collection of users to help guide the use of the SDA framework, and provide comfort to non-technical users. In addition, this network allows for the SDA framework to monitor statistical analytic usage, behavior, and load among a group of users, which then allows the system to balance demand with predictive performance to individual users.

The SDA framework allows for a novel interaction with statistical analytics. Once a statistical analytic is visualized in the SDA framework for presentation to the user, the user has the ability to use all statistical analytics, or components thereof (bars from bar graphs, segments of pie graphs, among many others) as search query parameters. By dragging the statistical analytic or component thereof into the search space, the user will have established an associative key-value array query parameter containing all relevant information and data associated with the dragged item. Thus, created is a hierarchical list of key-value pairs, whose order is determined by absolute frequency of occurrence in unique records, and relative position of similar values within records. This is important because it is this mechanism that creates a vector comprising the pertinent information contained within the analytic for translation into a query parameter. The user generated weight from the search space then is propagated into the associative key-value array, again leveraging the human intuition and thought captured through the graphical user interface and transferring it to machine logic that adds an extra dimension within the statistical analytic. The addition of this translated machine logic into the statistical analytic grants the user the ability to direct the statistical analytic intuitively, a completely novel methodology. The same methodology is also applicable in regards to a search result. By simply dragging the result into the search space, the user will have again transferred the characteristics, parameters, and key elements of that result into an associative key-value array and incorporated said array into a search query parameter. By filtering out the original parameters, the analytic vector translated into a query parameter is unique, allowing for otherwise unseen associations to be exposed. Similar to above, the weight assigned to the query parameter through the search space is again propagated down into the array. This methodology contained within the SDA framework allows for a novel methodology to interact with statistical analytics and results.

The draggable statistical analytics and components thereof described above allows the SDA framework to enable users to construct search queries using statistical analytics and components thereof as the query parameters. This framework allows for multiple statistical analytics comprising modeled insights from disparate topics or datasets to be queried in concert. The result of this query constructed allows for commonalities and hidden associations contained within the dataset(s) to be extracted, achieving the elicitation of insight from big data established as the goal above.

The SDA framework's ability to enable statistical analytics and components thereof to be dragged into the search space to be used as search query parameters also allows for turning on, turning off, and scaling up and down (in terms of importance) query parameters disparate from the statistical analytic query parameters. If a user searches with a query parameter that is disparate from the statistical analytic parameter in conjunction with the statistical analytic parameter, the weight from the query parameter adds an additional variable to the statistical analytic parameter model. Additionally, the SDA framework allows for the variables comprising the statistical analytic that generated the statistical analytic query parameter to be broken out within the search space and weighted against each other or among each other. As the variables are weighted among each other, the user is enabled to perform a novel means of contingency analysis to test the veracity of the statistical analytic as well as results it produces. This is another example of how the SDA framework unifies search and statistical analysis to become a more productive expression of user intent and analysis.

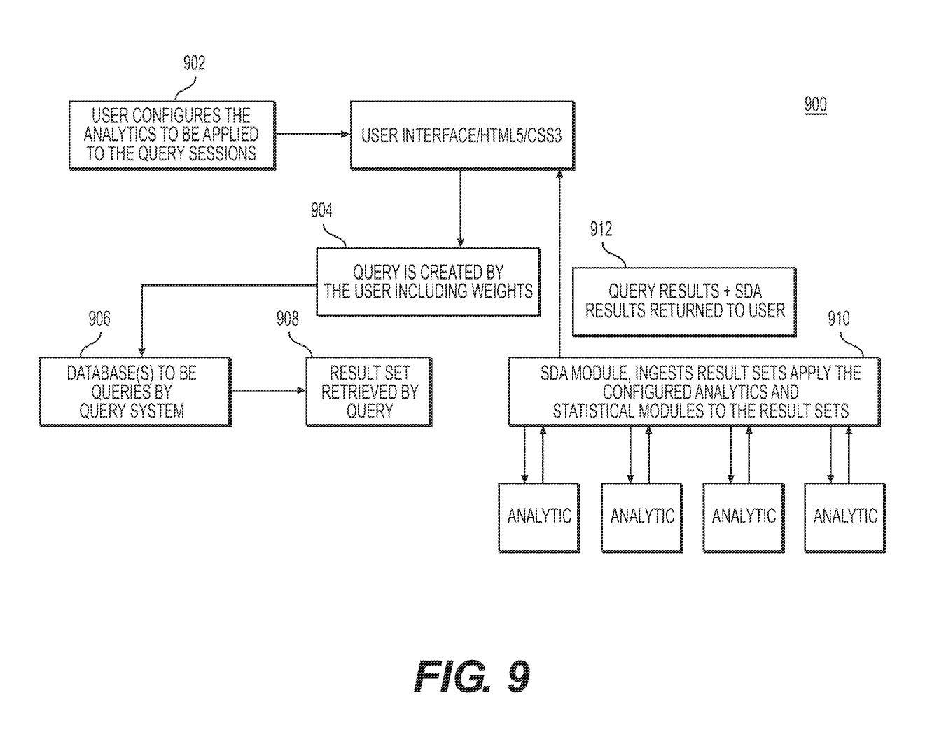

FIG. 9 depicts an SDA framework that enables a method 900 to perform comparative analytics, according to embodiments of the disclosure. Through a designated box, which may be referred to as the Analytic Drop Zone (“ADZ”), the user may be able to store statistical analytics, and components thereof for later use. When running a completely disparate search query, the user may select the stored statistical analytic from the ADZ and drop it into the search space. The stored statistical analytic may be used as a search query parameter. This framework is a novel method to construct simultaneous queries across disparate topics and datasets to discover and elicit insights from the complete scope of big data, rather than the silos of particular datasets.

The following steps are utilized to perform the SDA. In one embodiment, as shown in FIG. 9, an analytic may be run in parallel with the search. As shown in step 902, a user may select a set of analytics that he and/or she wants applied to a query session. At step 904, the query may be created through the search space query system, as discussed above. At step 906, the query may run on connected databases. As shown in step 908, the query may be returned from the connected databases as a collection of relevant, weighted results. The raw results may or may not be presented to the user. The systems and methods may collect relevant, weighted results, which may be passed to the SDA module within the system architecture (Step 910). At step 910, the SDA module may execute statistical models and analytics previously selected by the user on the query results. For example, possible analytics or statistical models performed by the SDA module include, but are not limited to, counts on structured variables (count and visualize publication dates); cohort relevancy scoring; latent semantic analysis upon query results; and/or dictionary scoring (apply a dictionary to the query results for visualization). Once the SDA module has finished processing the query result set, the user may be presented with the processed results at step 912. The results may include one or more of a ranked set of results, and/or results of processed SDA module analytics and statistical models. Further, all or part of the SDA results may be visualized to the user, unless configured to show straight numerical information by user.

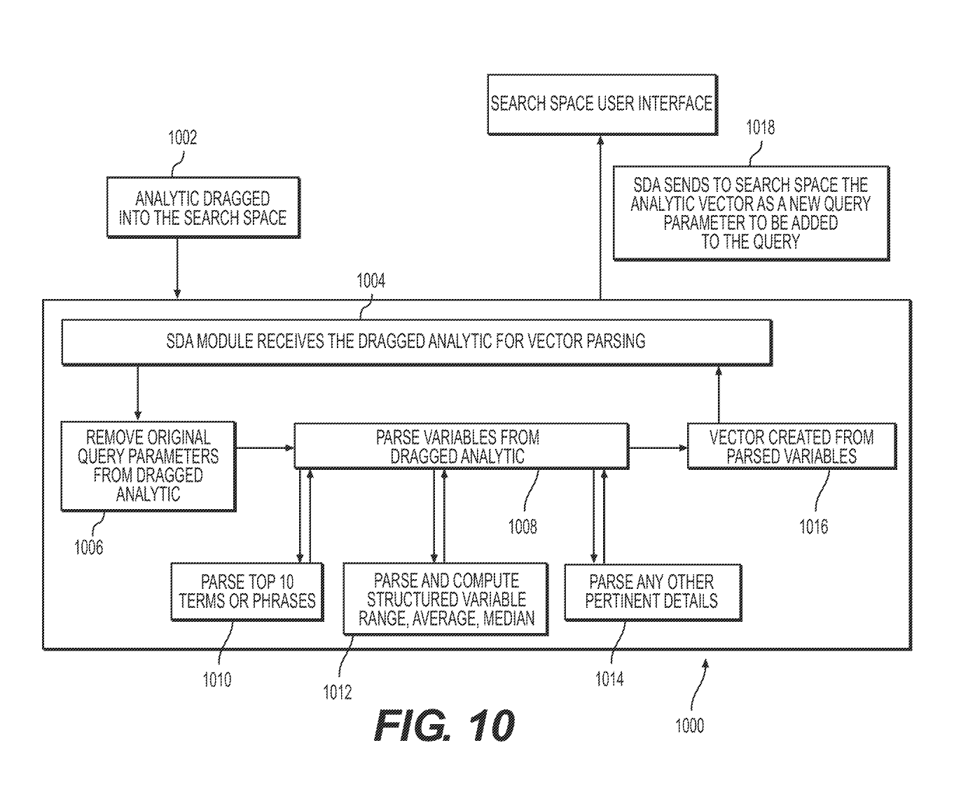

In another embodiment, as shown in FIG. 10, a user at step 1002 may drag an analytic and/or a component thereof into the search space to use the SDA module to transform the analytic into a search query parameter. The SDA module may receive the dragged analytic for vector parsing at step 1004. The SDA module may eliminate from the analytic the original search query parameters at step 1006. Then at step 1008, the SDA module may parse out the relevant information into a SDA query vector. Parsing may include, but is not limited to, extracting one or more most common terms or phrases from the text and placing the extractions into vector positions at step 1010. In one embodiment, the top ten (10) most common terms or phrases may be parsed from the text and placing the extractions into vector positions.

Parsing of step 1008 may include, but is not limited to, parsing date ranges, average, and/or medium at step 1012, and/or parsing nay other pertinent details at step 1014. At step 1016, the SDA module may create vectors from the parse variables, such as by placing them into vector positions. The SDA module may send the analytic vector to a search space at step 1018. The parsed SDA vector, which is now within the search space (as the user had previously dragged into the search space), may become associative as it takes the weight generated by the user through the search space. The weight may cascade down to be applied to the various parameters within the vector.

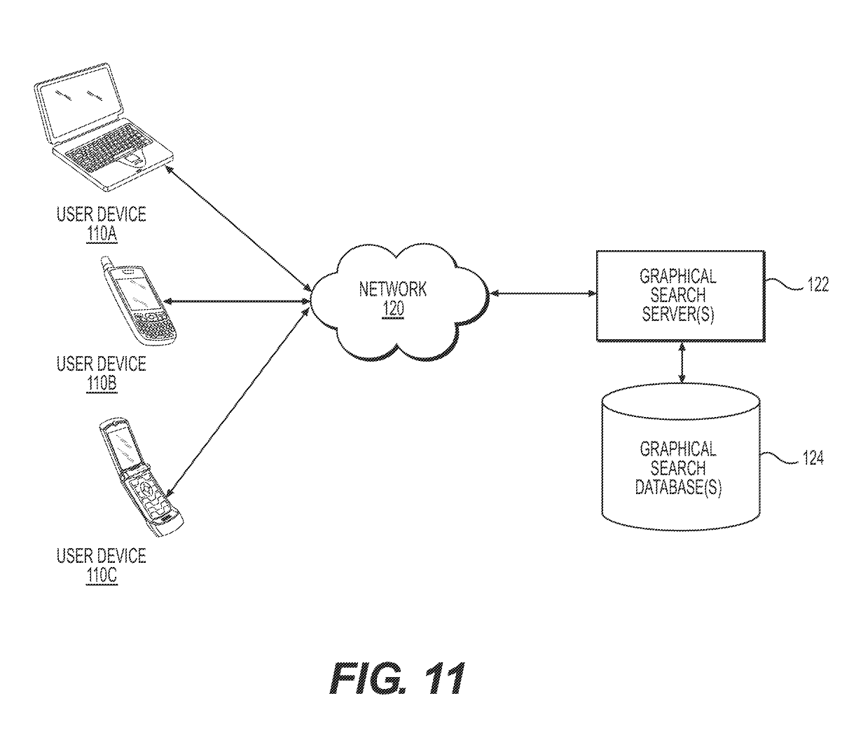

FIG. 11 depicts an exemplary environment and systems for enabling and using the presently disclosed graphical search interfaces. Any user device 110a may be a desktop, laptop, or other type of personal computer, user device 110b may be a tablet device or other type of mobile computing device having a touchscreen display, and user device 110c may be a mobile device, smartphone, and/or personal digital assistant (“PDA”). However, it should be noted that each of user devices 110a, 110b and 110c may be any type of electronic device configured to send and receive data, such as search results, websites, multimedia content, and electronic advertisements, over a network 120. Examples of such mobile computing devices include, but are not limited to, a laptop computer, a handheld computer, a PDA, a cellular telephone, a network appliance, a camera, a smart phone, an enhanced general packet radio service (“EGPRS”) mobile phone, a media player, a navigation device, a portable game console, or any combination of these computing devices or other types of mobile computing devices having at least one processor, a local memory, a display, one or more user input devices, and a network communication interface. The user input device(s) may include any type or combination of input/output devices, such as a display monitor, touchpad, touchscreen, microphone, camera, keyboard, and/or mouse.

Graphical search server(s) 122 may include SDA modules and may be configured to interact with user devices 110a-110c over network 120 to execute the exemplary method of FIG. 8. Graphical search server(s) 122 may each represent any of various types of servers including, but not limited to a web server, an application server, a proxy server, a network server, or a server farm. Graphical search server(s) 122 may be implemented using any general-purpose computer capable of serving data to other computing devices including, but not limited to, user devices 110a, 110b, 110c or any other computing device (not shown) via network 120. Such a general-purpose computer can include, but is not limited to, a server device having a processor and memory for executing and storing instructions. The memory may include any type of random access memory (RAM) or read-only memory (ROM) embodied in a physical storage medium, such as magnetic storage including floppy disk, hard disk, or magnetic tape; semiconductor storage such as solid state disk (SSD) or flash memory; optical disc storage; or magneto-optical disc storage. Software may include one or more applications and an operating system. Hardware can include, but is not limited to, a processor, memory and graphical user interface display. Each server may also have multiple processors and multiple shared or separate memory components that are configured to function together within, for example, a clustered computing environment or server farm. Graphical search server(s) 122 may be configured to interact with one or more database(s) 124, which may be any suitable type of distributed, local, and/or cloud-based data storage devices that can store indexed data, such as keywords, websites, etc., or any other data consistent with an online search engine database.

Program aspects of the technology may be thought of as “products” or “articles of manufacture” typically in the form of executable code and/or associated data that is carried on or embodied in a type of machine readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

While the presently disclosed sharing application, methods, devices, and systems are described with exemplary reference to applications for mobile applications, it should be appreciated that the presently disclosed embodiments may be applicable to any environment, such as a desktop or laptop computer, an automobile entertainment system, a home entertainment system, etc. Also, as previously noted, the presently disclosed embodiments may be applicable to any type of content, such as text content or video content.

The foregoing description has been presented for purposes of illustration and description. It is not intended to be exhaustive or to limit the disclosure to the precise form disclosed, and other modifications and variations may be possible in light of the above teachings. The embodiments were chosen and described in order to best explain the principles of the disclosure and its practical application to thereby enable others skilled in the art to best utilize the disclosure in various embodiments and various modifications as are suited to the particular use contemplated.

What is claimed is:

1. A computer-implemented method for enabling Internet users to interact with a graphical search interface, the method comprising:
receiving, from a user over an electronic network, an analytic to be queried;
generating, by a processor, an analytic parameter, based on the received analytic;
receiving, from the user over the electronic network, a search parameter;
generating, by the processor, a multi-dimensional search space, based on the generated analytic parameter and the received search parameter, wherein the multi-dimensional search space has a perimeter defined by the generated analytic parameter and the received search parameter;
transmitting, for display to the user over the network, a graphical interface projecting the multi-dimensional search space, along with one or more user elements by which the user may adjust a weighting of one or more of the generated analytic parameter and the received search parameter by interacting with the one or more user elements; and
transmitting, for display to the user over the network, a plurality of search results automatically updated in real time based on the user-adjusted weighting of the generated analytic parameter and the received search parameter.

2. The computer-implemented method of claim 1, further comprising:
enabling the user to change the weighting of one or more of the generated analytic parameter and the received search parameter by using the one or more user elements to change a spatial position of one or more of the generated analytic parameter and the received search parameter relative to each other.

3. The computer-implemented method of claim 1, wherein the weighting of each of the generated analytic parameter and the received search parameter is calculated based on a direct weighting and a relative weighting;
wherein the direct weighting is calculated based on either (i) a position of each of the one or more of the generated analytic parameter and the received search parameter of the perimeter, or (ii) a distance of each of the one or more of the generated analytic parameter and the received search parameter of the perimeter from a radial center of the multi-dimensional search space; and
wherein the relative weighting is calculated based on a distance of each of the one or more of the generated analytic parameter and the received search parameter of the perimeter to one or more of other user elements.

4. The computer-implemented method of claim 3, wherein the direct weighting and the relative weighting are derived from Euclidean coordinate points underlying the one or more of the generated analytic parameter and the received search parameter of the perimeter.

5. The computer-implemented method of claim 1, wherein the weighting of each of the generated analytic parameter and the received search parameter is calculated based on both of (i) a spatial distance between each of the one or more of the generated analytic parameter and the received search parameter of the perimeter and a radial center of the multi-dimensional search space; and (ii) a spatial distance and an angle between two or more of each of the one or more of the generated analytic parameter and the received search parameter of the perimeter.

6. The computer-implemented method of claim 5, wherein the spatial distance and the angle are calculated between two or more of each of the one or more of the generated analytic parameter and the received search parameter of the perimeter using a Euclidean geometry framework.

7. The computer-implemented method of claim 1, further comprising:
generating, by a processor, a matrix of hyperlinks within the multi-dimensional search space, each hyperlink having coordinates within the search space defining a relevance of each hyperlink to the generated analytic parameter and the received search parameter.

8. The computer-implemented method of claim 1, further comprising:
presenting, to the user over the network, the one or more user elements, such that the user can move each of the one or more user elements toward or away from a center and other user elements of the multi-dimensional search space to change a relative weight of one or more of the generated analytic parameter and the received search parameter.

9. The computer-implemented method of claim 1, wherein the perimeter of the multi-dimensional search space has a plurality of vertices, each vertex of the plurality of vertices representing one of the generated analytic parameter and the received search parameter employed in a search initiated by the user.

10. The computer-implemented method of claim 1, wherein each of the one or more user elements is a vertex of a plurality of parameter vertices in the multi-dimensional search space, and collective positions of parameter vertices to other vertices of the multi-dimensional search space represent the relative weightings or importance of each parameter in a user Internet search.

11. The computer-implemented method of claim 1, wherein each of the one or more user elements is a vertex of a plurality of parameter vertices in the multi-dimensional search space, and collective distances of parameter vertices to other vertices of the multi-dimensional search space represent the relative weightings or importance of each parameter in a user Internet search.

12. The computer-implemented method of claim 1, wherein the multi-dimensional search space has a center representing an optimal search output.

13. The computer-implemented method of claim 1, wherein, initially, the generated analytic parameter and the received search parameter have a predetermined weight, such that the multi-dimensional search space is a radial shape about an optimal search output.

14. The computer-implemented method of claim 1, further comprising:
enabling the user to simultaneously examine multiple data sets; and
searching for an intersection by joining parameters common to each data set, by joining search spaces of each data set.

15. A system for enabling Internet users to interact with a graphical search interface, the system including:
a data storage device that stores instructions for enabling Internet users to interact with a graphical search interface; and
a processor configured to execute the instructions to perform a method including:
receiving, from a user over an electronic network, an analytic to be queried;
generating, by a processor, an analytic parameter, based on the received analytic;
receiving, from the user over the electronic network, a search parameter;
generating, by the processor, a multi-dimensional search space, based on the generated analytic parameter and the received search parameter, wherein the multi-dimensional search space has a perimeter defined by the generated analytic parameter and the received search parameter;
transmitting, for display to the user over the network, a graphical interface projecting the multi-dimensional search space, along with one or more user elements by which the user may adjust a weighting of one or more of the generated analytic parameter and the received search parameter by interacting with the one or more user elements; and
transmitting, for display to the user over the network, a plurality of search results automatically updated in real time based on the user-adjusted weighting of the generated analytic parameter and the received search parameter.

16. The system of claim 15, wherein the processor is further configured to execute the instructions to perform the method including:
enabling the user to change the weighting of one or more of the generated analytic parameter and the received search parameter by using the one or more user elements to change a spatial position of one or more of the generated analytic parameter and the received search parameter relative to each other.

17. The system of claim 15, wherein the weighting of each of the generated analytic parameter and the received search parameter is calculated based on a direct weighting and a relative weighting;
wherein the direct weighting is calculated based on either (i) a position of each of the one or more of the generated analytic parameter and the received search parameter of the perimeter, or (ii) a distance of each of the one or more of the generated analytic parameter and the received search parameter of the perimeter from a radial center of the multi-dimensional search space; and
wherein the relative weighting is calculated based on a distance of each of the one or more of the generated analytic parameter and the received search parameter of the perimeter to one or more of other user elements.

18. The system of claim 15, wherein, initially, the generated analytic parameter and the received search parameter have a predetermined weight, such that the multi-dimensional search space is a radial shape about an optimal search output.

19. A non-transitory computer-readable medium storing instructions that, when executed by a computer, cause the computer to perform a method for enabling Internet users to interact with a graphical search interface, the method including:
receiving, from a user over an electronic network, an analytic to be queried;
generating, by a processor, an analytic parameter, based on the received analytic;
receiving, from the user over the electronic network, a search parameter;
generating, by the processor, a multi-dimensional search space, based on the generated analytic parameter and the received search parameter, wherein the multi-dimensional search space has a perimeter defined by the generated analytic parameter and the received search parameter;
transmitting, for display to the user over the network, a graphical interface projecting the multi-dimensional search space, along with one or more user elements by which the user may adjust a weighting of one or more of the generated analytic parameter and the received search parameter by interacting with the one or more user elements; and
transmitting, for display to the user over the network, a plurality of search results automatically updated in real time based on the user-adjusted weighting of the generated analytic parameter and the received search parameter.

20. The computer-readable medium of claim 19, wherein, initially, the generated analytic parameter and the received search parameter have a predetermined weight, such that the multi-dimensional search space is a radial shape about an optimal search output.
